(19) United States
(12) Patent Application Publication
(10) Pub. No.: US 2020/0182801 A1
(43) Pub. Date: Jun. 11, 2020

(54) LIGHTING DEVICE AND INSPECTION APPARATUS

(71) Applicant: AGENCY FOR SCIENCE, TECHNOLOGY AND RESEARCH, Singapore (SG)

(72) Inventor: Zhongping FANG, Singapore (SG)

(21) Appl. No.: 16/085,551

(22) PCT Filed: Mar. 16, 2017
(86) PCT No.: PCT/SG2017/050131

§ 371 Date: Sep. 14, 2018

(30) Foreign Application Priority Data
Mar. 16, 2016 (SG) 10201602037R

(51) Int. Cl. G01N 21/88; F21V 7/00

(52) U.S. Cl. CPC G01N 21/8806; F21Y 2115/10; G01N 2021/8816; F21V 7/0025

(57) ABSTRACT

A lighting device for an inspection apparatus. The lighting device may include a hollow housing having an inner planar reflective surface and an opposing inner concave dome-shaped reflective surface. The lighting device may further include at least one light source disposed at the inner planar reflective surface. The hollow housing may include an opening configured to be a light outlet. An inspection apparatus including the lighting device and an imaging device coupled to the lighting device.

### CROSS-REFERENCE TO RELATED APPLICATIONS

This application claims the benefit of Singapore Patent Application number 10201602037R filed on 16 Mar. 2016, the entire contents of which are incorporated herein by reference for all purposes.

### TECHNICAL FIELD

Embodiments generally relate to a lighting device and an inspection apparatus.

### BACKGROUND

Line-scan machine vision systems are widely used in industry for high speed in-line inspections. Most of the industrial applications for line scan vision inspection are for inspections that are conducted at very high speed, such as 100 or 120 meters per minute. Accordingly, the exposure time for capturing of image of each line in such application is very short, typically, in the range of microseconds. Thus, the line-scan machine vision inspection systems are usually provided with extremely strong intensity lighting in order to capture image at such short exposure time.

U.S. Pat. No. 6,783,068 discloses an example of a line-scan inspection system. As shown, the line-scan inspection system has a line-lighting source that creates a light plane which is projected onto the transport system. Light reflected from the object on the transport system is then focused onto a sensor through an objective lens.

FIG. 1 shows a typical line-lighting source 10 for a line-scan inspection system. The typical line-lighting source 10 would include a bar light 12 and a cylindrical lens 14. In such arrangement, the cylindrical lens 14 would focus the bar light 12 into a fine line 16 with extremely high intensity for projecting onto the transport system. Although the cylindrical lens 14 can condense the lighting and focus the light into the line 16 and provide very high intensity for line-scan machine vision inspection system to capture image at high speed, such lighting devices 10 suffer from lighting uniformity problem. Further, if the object to be inspected contains reflective packaging or surfaces, the line-lighting may cause inconsistent lighting due to specular reflection of the highly directional line-lighting resulting in hot spots or dark spots.

Another type of inspection systems used in industrial application is area-scan inspection systems. Typically, area-scan inspection systems are used for inspecting objects that are momentarily stop or moving extremely slowly. The area-scan inspection systems would usually have a diffuse lighting source to provide uniform lighting to illuminate the entire object for machine vision inspection. Usually, the diffuse lighting source is in the form of a diffuse dome-lighting source. The diffuse dome-lighting source typically radiates indirect diffused light to light up the object for inspection from every direction to uniformly illuminate the object. Such diffuse dome-lighting is also known as cloudy lighting. The light intensity of diffuse dome lighting is generally low. Thus, such diffuse dome lighting cannot be used in a line-scan inspection system. Further, the diffuse dome-lighting can only uniformly illuminate objects that are confined within the dome. Thus, the size of the objects to be inspected is limited. Accordingly, such diffuse dome-lighting is limited to area-scan inspections only.

To address the need of illuminating objects with high aspect ratios, such as larger objects with wide or thin or elongated profiles, diffuse tube lighting has been recently developed. The diffuse tube lighting share the benefits of diffuse dome lighting, but is structured in an elongated manner to illuminate elongated objects.

### SUMMARY

According to various embodiments, there is provided a lighting device including a hollow housing having an inner planar reflective surface and an opposing inner concave dome-shaped reflective surface. The lighting device may further include at least one light source disposed at the inner planar reflective surface. The hollow housing may include an opening configured to be a light outlet.

According to various embodiments, there is provided an inspection apparatus including a lighting device as described herein and an imaging device coupled to the lighting device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a line-lighting source according to prior art;

FIG. 2 shows a cut out view of a lighting device according to various embodiments;

FIG. 3 shows an inspection apparatus having a lighting device according to various embodiments;

FIG. 4 shows a bottom view of the lighting device of the inspection apparatus of FIG. 3 according to various embodiments;

FIG. 5 shows an inspection apparatus having a lighting device according to various embodiments; and

FIG. 6 shows a lighting device for an inspection apparatus according to various embodiments.

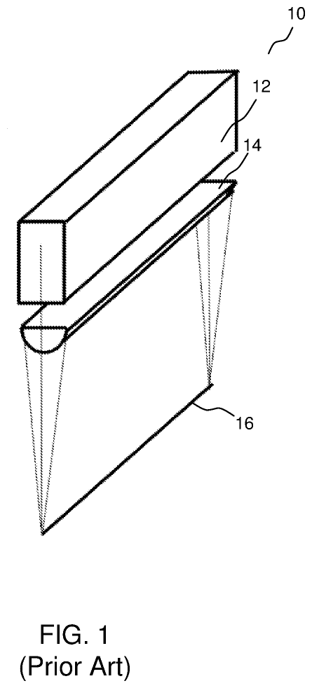

### DETAILED DESCRIPTION

Embodiments described below in context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various embodiments of a lighting device and/or an inspection apparatus based on machine vision have been provided to address at least some of the issues identified earlier.

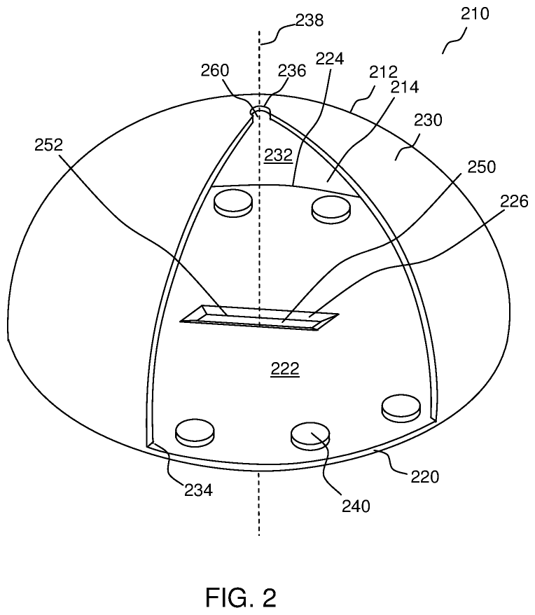

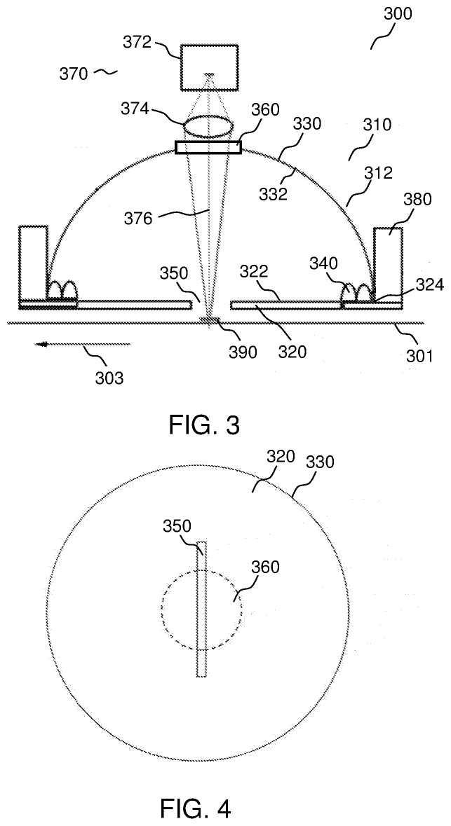

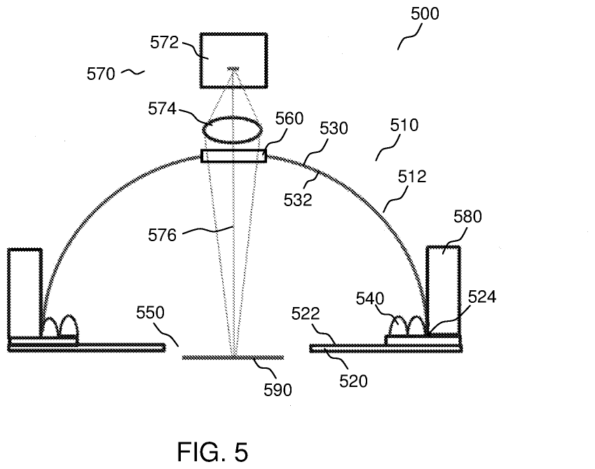

FIG. 2 shows a cut-out view of a lighting device 210 for an inspection apparatus based on machine vision according to various embodiments. FIG. 3 shows a schematic diagram of an inspection apparatus 300 for line-scanning having a lighting device 310 according to various embodiments. FIG. 5 shows a schematic diagram of an inspection apparatus 500 for area-scanning having a lighting device 510 according to various embodiments. Various embodiments of the lighting device 210, for example as shown in FIG. 2, may be used as the lighting device 310 of the inspection apparatus 300 of FIG. 3 and/or the lighting device 510 of the inspection apparatus 500 of FIG. 5.

As shown in FIG. 2, various embodiments of the lighting device 210 for an inspection apparatus may include a hollow housing 212. The hollow housing 212 may be an exterior casing of the lighting device 210. Accordingly, the hollow housing 212 may enclose a space to define a cavity 214 within the hollow housing 212.

According to various embodiments, the hollow housing 212 may include an inner planar reflective surface 222 and an opposing inner concave dome-shaped reflective surface 232. Accordingly, the inner planar reflective surface 222 of the hollow housing 212 may be a surface (or a first surface) of an interior of the hollow housing 212 that is flat and that may be capable of casting back or reflecting light that strikes on the surface. The inner concave dome-shaped reflective surface 232 of the hollow housing 212 may be another surface (or a second surface) of the interior of the hollow housing 212 that may be hollowed or rounded inward resembling an interior of a hollow hemisphere or like the inside of a bowl, and that may also be capable of casting back or reflecting light that strikes on the surface. The inner planar reflective surface 222 may be directly facing the inner concave dome-shaped reflective surface 232 such that the inner concave dome-shaped reflective surface and the inner planar reflective surface 222 may be opposing and may enclose a space in between to define the cavity 214 of the hollow housing 212.

According to various embodiments, a base edge 234 of the inner concave dome-shaped reflective surface 232, which is opposite an apex 236 of the inner concave dome-shaped reflective surface 232 and having the widest perimeter, may be superimposed exactly over the opposing inner planar reflective surface 222. Hence, an edge 224 of the inner planar reflective surface 222 may be adjoining the base edge 234 of the opposing inner concave dome-shaped reflective surface 232. Accordingly, the shape and size of the inner planar reflective surface 222 may be configured to correspond or match the shape and size of the base of the inner concave dome-shaped reflective surface 232. According to various embodiments, the inner concave dome-shaped reflective surface 232 may be hemispherical in shape. Accordingly, the base edge 234 of the inner concave dome-shaped reflective surface 232 may be a circular shape. Thus, the shape of the inner planar reflective surface 222 may be circular. According to various embodiments, the inner concave dome-shaped reflective surface 232 may be formed by multiple curved surface segments. Accordingly, the base edge 234 of the inner concave dome-shaped reflective surface 232 may be a polygonal shape, such as octagonal shape or decagonal shape or dodecagonal shape or any other polygonal shape with suitable number of sides depending on the number of segments forming the inner concave dome-shaped reflective surface 232. Thus, the shape of the inner planar reflective surface 232 may be a polygonal shape with corresponding number of sides.

According to various embodiments, the inner planar reflective surface 222 may be configured to be a specularly-reflective surface. Accordingly, the inner planar reflective surface 222 may be a surface that causes specular reflection of light similar to the way light is reflected (at just one angle) off a mirror or a speculum. According to various embodiments, the inner planar reflective surface 222 may include a mirror surface such as that of a glass mirror, an acrylic mirror or a sheet of metal with a high reflective coating. Accordingly, when the mirror surface of the inner planar reflective surface 222 is of a front surface mirror, the reflectivity of the inner planar reflective surface 222 may be 97% or higher. When the mirror surface of the inner planar reflective surface 222 is of a plastic reflector, the reflectivity of the inner planar reflective surface 222 may be between 70% to 90%. When the mirror surface of the inner planar reflective surface 222 is of a home mirror (back-sided mirror), the reflectivity of the inner planar reflective surface 222 may be about 80%.

According to various embodiments, the inner planar reflective surface 222 may include a diffuse reflectance coating. Accordingly, the inner planar reflective surface 222 may cause diffuse reflection of light whereby light may be reflected at many angles rather than at just one angle. Hence, light may be reflected in a diffused and scattered manner off the inner planar reflective surface 222. According to various embodiments, the inner planar reflective surface 222 may include a barium sulphate based formulation coating. Accordingly, the reflectivity of the inner planar reflective surface 222 may be 90% or higher. The inner planar reflective surface 222 may also include other coating with reflectivity of 50% or higher.

According to various embodiments, the inner concave dome-shaped reflective surface 232 may include a diffuse reflectance coating. Accordingly, the inner concave dome-shaped reflective surface 232 may cause diffuse reflection of light whereby light may be reflected at many angles rather than at just one angle. Hence, light may be reflected in a diffused and scattered manner off the inner concave dome-shaped reflective surface 232. According to various embodiments, the inner concave dome-shaped reflective surface 232 may include a white reflectance coating. According to various embodiments, the inner concave dome-shaped reflective surface 232 may include a barium sulphate based formulation coating. Accordingly, the reflectivity of the inner concave dome-shaped reflective surface 232 may be 90% or higher. The inner concave dome-shaped reflective surface 232 may also include other coating with reflectivity of 50% or higher.

As shown in FIG. 2, the exterior shape of the hollow housing 212 may be a dome-shape. According to various embodiments, the exterior shape of the hollow housing 212 may be of any suitable shape that allows the interior of the hollow housing 212 to include the inner planar reflective surface 222 and the opposing inner concave dome-shaped reflective surface 232. For example, other suitable exterior shape of the hollow housing 212 may include cuboid shape, cylindrical shape, conical shape, prism shape, or frusta shape.

According to various embodiments, the hollow housing 212 may include a base part (or a first part) 220 having the inner planar reflective surface 222 and a cover part (or a second part) 230 having the opposing inner concave dome-shaped reflective surface 232. According to various embodiments, the base part 220 and the cover part 230 may be two separate parts of the hollow housing 212. Accordingly, the base part 220 of the hollow housing 212 may be a bottom case cover of the exterior casing of the lighting device 210. The cover part 230 of the hollow housing 212 may be a top case cover of the exterior casing of the lighting device 210. According to various embodiments, the base part 220 may be removably coupled to the cover part 230. Accordingly, the base part 220 and the cover part 230 may be configured such that the base part 220 may be separated from the cover part 230 after being coupled together. For example, the base part 220 and the cover part 230 may include suitable fastening features, for example screw thread or snap-fit features, to allow the base part 220 and the cover part 230 to be fastened together and subsequently unfasten so as to be separated apart. According to various other embodiments, the base part 220 and the cover part 230 may be integrally molded as a single unitary piece.

According to various embodiments, the base part 220 of the hollow housing 212 may be a panel or a sheet of rigid material or a solid plate. Accordingly, one side of the panel or the sheet of rigid material or the solid plate may be configured to be reflective to form the inner planar reflective surface 222 of the hollow housing 212. According to various embodiments, the base part 220 may include a mirror such as a glass mirror, front surface mirror, back-sided mirror, an acrylic mirror or a sheet of metal with a high reflective coating.

According to various embodiments, the cover part 230 of the hollow housing 212 may include a hollow dome-shaped shell structure. Accordingly, the hollow dome-shaped shell structure may have a uniform thickness such that the shape of the interior hollow surface of the dome-shaped shell corresponds to the dome-shaped exterior surface to form the inner concave dome-shaped reflective surface 232 of the hollow housing 212. According to various other embodiments, the cover part 230 of the hollow housing 212 may include a recess portion shaped and configured to form the inner concave dome-shaped reflective surface 232 of the hollow housing 212. Accordingly, the exterior shape of the cover part 230 of the hollow housing 212 may be of any suitable shape that allows the recess portion to be formed. For example, other suitable exterior shape of the cover part 230 of the hollow housing 212 may include cuboid shape, cylindrical shape, conical shape, prism shape, or frusta shape.

Referring back to FIG. 2, various embodiments of the lighting device 210 may further include at least one light source 240. The at least one light source may be disposed inside the hollow housing 212 such that the at least one light source may be enclosed or housed within the cavity of the hollow housing 212. The at least one light source 240 may include any suitable light emitting source such as a light-emitting diode, or an organic light-emitting diode, or a polymer light-emitting diode, or an arc lamp, or a fluorescent lamp, or an incandescent lamp, or the like. According to various embodiments, the at least one light source 240 may be disposed at the inner concave dome-shaped reflective surface 232. According to various other embodiments, the at least one light source 240 may be disposed at the inner planar reflective surface 222. For example, the at least one light source 240 may be disposed at any portion of the inner planar reflective surface 222. As shown in FIG. 2, the at least one light source 240 may be disposed at least substantially at the edge 224 of the inner planar reflective surface 222. Accordingly, the at least one light source 240 may be arranged or placed along (and/or in the vicinity of) the border or boundary of the inner planar reflective surface 222. The at least one light source 240 may be configured to be operable in a continuous lighting mode and/or a trigger lighting mode.

According to various embodiments, the lighting device 210 may include multiple light sources 240 arranged and disposed at any portions of the inner planar reflective surface 222 and/or at any portions of the inner concave dome-shaped reflective surface 232. For example, as shown in FIG. 2, the lighting device 210 may include multiple light sources 240, which may be in the form of point sources, uniformly spaced apart along the edge 224 of the inner planar reflective surface 222. According to various embodiments, the lighting device 210 may include multiple light sources 240, which may be in the form of light strips or light tubes, uniformly placed and spaced around the edge 224 of the inner planar reflective surface 222. According to various embodiments, the lighting device 210 may include multiple light sources 240, which may be arranged or disposed on the inner planar reflective surface 222 such that the multiple light sources 240 may be uniformly placed across the whole surface of the inner planar reflective surface 222. According to various embodiments, the lighting device 210 may include one light source 240, which may be in the form of a ring shape or circular tube shape, lining the edge 224 of the inner planar reflective surface 222.

According to various embodiments, the base of the inner concave dome-shaped reflective surface 232 may mainly include the inner planar reflective surface 222 and the light sources 240. The light sources 240 may input, enhance or increase the light energy within the cavity of the hollow housing 212 of the lighting device 210. The inner planar reflective surface 222 may reduce or minimize light energy loss by reflecting the light energy. Accordingly, except of the area or the space taken up by the light sources 240, the remaining possible area or space may be taken up by the inner planar reflective surface 222 so as to minimize light lose and increase the light intensity within the lighting device 210.

As shown in FIG. 2, the hollow housing 212 of the lighting device 210 may include an opening 250 configured to be a light outlet. Accordingly, light from the at least one light source 240 inside the hollow housing 212 of the lighting device may be subjected to multiple reflection via the inner planar reflective surface 222 and the opposing inner concave dome-shaped reflective surface 232 such that the light from the at least one light source 240 may be integrated, focused or concentrated at the opening 250 of the hollow housing 212 for the lighting device 210 to emit a high intensity light through the opening 250.

According to various embodiments, the inner planar reflective surface 222 of the hollow housing 212 may include the opening 250 or the light outlet for light to escape from the lighting device 210 such that light may be projected from the lighting device 210 through the opening 250 of the hollow housing 212. Accordingly, the lighting device 210 may include the opening 250 at the inner planar reflective surface 222 for light to be cast out from the lighting device 210. When the opening 250 is at the inner planar reflective surface 222, light casting out from the opening 250 may provide a uniform lighting or illumination.

According to various embodiments, the opening 250 may be configured such that an area of the opening 250 may be much smaller than an area of the inner planar reflective surface 222. The area of the opening 250 may be the extent of the gap provided by the opening 250. The area of the inner planar reflective surface 222 may be the extent of the surface defined between the perimeter of the inner planar reflective surface 222 and the perimeter of the opening 250. According to various embodiments, the area of the opening 250 may be less than 30%, or less than 20%, or less than 10% of the whole of the area of the inner planar reflective surface 222.

According to various embodiments, the opening 250 of the inner planar reflective surface 222 of the hollow housing 212 of the lighting device 210 may be configured to funnel or direct the light escaping from within the cavity of the hollow housing 212 through the opening 250 of the hollow housing 212 to form a predetermined shape on a surface the light is projected on. The predetermined shape may be a narrow strip resembling a line, or a circular shape, or a quadrilateral shape. As shown in FIG. 2, the opening 250 of the inner planar reflective surface 222 may include a slit resembling a narrow rectangle. Accordingly, light escaping from the opening 250 in the form of a slit may be funnelled or directed to form a narrow strip of light resembling a line. Hence, the lighting device 210 with the opening 250 in the form of a slit (similar to the lighting device 310 of the inspection apparatus 300 of FIG. 3) may be suitable for line-scanning applications. According to various embodiments, the opening 250 of the inner planar reflective surface 222 may include a circular hole or a square hole. Accordingly, light escaping from the opening 250 in the form of a circular hole or a square hole may then be funnelled or directed to form a circular shape or a square shape respectively. Hence, the lighting device 210 with the opening 250 in the form of a circular hole or square hole (similar to the lighting device 510 of the inspection apparatus 500 of FIG. 5) may be suitable for area-scanning applications. According to various embodiments, when the desired inspection area is large, the size of the hollow housing 212 as well as the inner planar reflective surface 222 and the opposing inner concave dome-shaped reflective surface 232 may be configured accordingly such that the opening 250 may be appropriately sized to fulfil the desired lighting or illumination requirements.

According to various embodiments, the opening 250 of the inner planar reflective surface 222 may be at least substantially at a centre of the inner planar reflective surface 222, for example as shown in FIG. 2. Accordingly, the opening 250 may be located at or near a geometric centre of the inner planar reflective surface 222.

According to various embodiments, a region 226 of the inner planar reflective surface 222 abutting a boundary 252 of the opening 250 of the inner planar reflective surface 222 may be chamfered, for example as shown in FIG. 2. Accordingly, the stretch of the inner planar reflective surface 222 laying adjacent to or bordering upon the opening 250 may be inclined relative to the inner planar reflective surface 222. According to various embodiments, the region 226 of the inner planar reflective surface 222 may be chamfered or inclined at an angle of 45 degrees.

As shown in FIG. 2, the inner concave dome-shaped reflective surface 232 may include an aperture 260. According to various embodiments, the aperture 260 may be configured to be a window for an imaging device to capture image observable through the aperture 260. Accordingly, the aperture 260 may be configured for coupling with the imaging device. The aperture 260 may be of any suitable shape. For example, as shown in FIG. 2, the aperture 260 may be a circular hole. According to various other embodiments, the aperture 260 may be an elliptical hole or a rectangular hole. According to various embodiments, the aperture 260 may hold or may be filled with a piece of glass or transparent material.

According to various embodiments, the aperture 260 of the inner concave dome-shaped reflective surface 232 may be at least substantially at the apex 236 of the inner concave dome-shaped reflective surface 232. Accordingly, the aperture 260 may be at or near a crown (or peak or vertex or summit or top) of the inner concave dome-shaped reflective surface 232. According to various embodiments, a vertical axis (or an axis of symmetry) 238 of the inner concave dome-shaped reflective surface 232 may pass through the aperture 260 of the inner concave dome-shaped reflective surface 232.

According to various embodiments, the aperture 260 of the inner concave dome-shaped reflective surface 232 and the opening 250 of the inner reflective planar surface 222 may be configured to be aligned such that a line may pass through both the aperture 260 of the inner concave dome-shaped reflective surface 232 and the opening 250 of the inner reflective planar surface 222. According to various embodiments, the vertical axis (or the axis of symmetry) 238 of the inner concave dome-shaped reflective surface 232 may pass through both the aperture 260 of the inner concave dome-shaped reflective surface 232 and the opening 250 of the inner reflective planar surface 222.

According to various embodiments, the hollow housing 212 of the lighting device 210 may be configured to be coupled with an imaging device (for example imaging device 370, 570 of FIG. 3 and FIG. 5 respectively) such that an optical axis of the imaging device may pass through both the aperture 260 of the inner concave dome-shaped reflective surface 232 and the opening 250 of the inner reflective planar surface 222. Accordingly, the exterior of the hollow housing 212 may be configured to include engagement fittings for coupling the imaging device to the hollow housing 212. Further, the hollow housing 212 of the lighting device 210 may be configured to couple with the imaging device such that the optical axis of the imaging device may at least substantially coincide with the vertical axis (or the axis of symmetry) 238 of the inner concave dome-shaped reflective surface 232. Accordingly, the imaging device and the inner concave dome-shaped reflective surface 232 may share a common axis.

According to various embodiments, inner concave dome-shaped reflective surface 232 may include multiple apertures 260 disposed at different positions and angles across the inner concave dome-shaped reflective surface 232. This may allow stereo vision or three dimensional inspections or the like.

According to various embodiments, the opening 250 of the inner reflective planar surface 222 may be configured or dimensioned or sized such that the opening 250 may at least accommodate the field of view of the imaging device. The field of view of the imaging device may be the area or the extent that may be observable by or visible to the imaging device for imaging.

According to various embodiments, the lighting device 210 may further include a heat sink coupled to the hollow housing 212. Accordingly, the heat sink may be configured to dissipate heat generated from within the lighting device 210. The heat sink may include a passive heat sink with a plurality of fins. Hence, heat may be dissipated to the ambient air via the plurality of fins.

According to various embodiments, the heat sink may be in thermal connection with the at least one light source 240. Accordingly, the heat sink may dissipate heat generated in the at least one light source 240 to the ambient air.

According to various embodiments, an inspection apparatus may include the lighting device 210 and an imaging device coupled to the lighting device 210. The imaging device may be coupled to the lighting device 210 such that an optical axis of the imaging device may pass through both the aperture 260 of the inner concave dome-shaped reflective surface 232 of the lighting device 210 and the opening 250 of the inner reflective planar surface 222 of the lighting device 210. Accordingly, an object placed below the opening 250 of the lighting device 210 may be illuminated by the lighting device 210 and the imaging device may capture image of the illuminated object.

According to various embodiments, the imaging device of the vision inspection apparatus may include an optical lens and an image sensor. The optical lens may be coupled to or placed at the aperture 260 of the inner concave dome-shaped reflective surface 232 of the lighting device 210. The image sensor may be aligned with the optical lens and arranged a distance apart from the optical lens along the optical axis of the imaging device. The image sensor may include a charge-coupled device (CCD) sensor or a complementary metal-oxide semiconductor (CMOS) sensor. Accordingly, the optical lens may focus an image of the illuminated object on the image sensor for image capturing.

FIG. 3 shows a schematic diagram of an inspection apparatus 300 having a lighting device 310 according to various embodiments. The lighting device 310 of the inspection apparatus 300 may be an embodiment of the lighting device 210 of FIG. 2. FIG. 4 shows a bottom view of the lighting device 310 of the inspection apparatus 300 of FIG. 3. According to various embodiments, the inspection apparatus 300 may be an inspection apparatus based on machine vision and the inspection apparatus 300 may be suitable for line-scanning. As shown in FIG. 3, an elongated sample 301 (or a long sample to be inspected) may be moved in a scan direction as indicated by arrow 303 such that the sample 301 may be inspected by the inspection apparatus 300. According to various embodiments, the inspection apparatus 300 may include the lighting device 310 and an imaging device 370. As shown in FIG. 3, the lighting device 310 may include an integrating dome lighting system which may include a half-sphere dome 330 (or a dome-shaped cover part having an inner concave dome-shaped reflective surface 332), a group of high power LED 340 (or at least one light source), a heat sink 380, and a mirror 320 (or a planar base part having an inner planar reflective surface 322) with a slit 350 (or an opening in the planar base part).

The half-sphere dome 330 may be the main body of the integrating lighting device 310. The internal surface 332 (or the inner concave dome-shaped reflective surface) of the half sphere 330 may be coated with high reflective coating and the circle opening at the base of the half sphere 330 may be covered by the high reflectance mirror 320.

The scanning slit 350 may be at the centre of a mirror surface 322 of the mirror 320. The slit 350 may be a narrow and short slit with dimensions sufficient or big enough to cast a light (in the form of a line light) to cover the full scanning area (or scanning width) of the sample (or the target object). The scanning slit 350 may be configured or sized or dimensioned so as to accommodate the field of view 390 of the imaging device 370, which may be a line or a stripe. Accordingly, the lighting device 310 with the slit 350 may be configured to illuminate the field of view 390 of the imaging device 370.

The half-sphere dome 330 may include an imaging opening 360 (or a hole or an aperture). The imaging opening 360 on the top of the half-sphere dome 330 (or the apex of the hemisphere) may be configured for the digital camera 372 (or an image sensor), such as a line-scan camera, to take images. The imaging opening 360 may be as small as possible. As a result, all of the lighting of the high-power LEDs 340 may be trapped inside of the half-sphere dome 330, and eventually fully be used for the line-scanning imaging.

Many high-power LED lights 340 may be arranged at the bottom of the half-sphere dome 330 (on the edge of the mirror 320) inside of the integrating lighting device 310 and heat sinks 380 may be at the outside of the integrating lighting device 310. Accordingly, the larger the diameter of the base of the half-sphere dome 330, the more high-power LEDs 340 may be installed inside of the integrating lighting device 310. The high-power LEDs 340 may be working based on continuous lighting mode or trigger lighting mode.

The imaging device 370 may include an optical lens 374 and the digital camera 372. The optical lens 374 and the digital camera 372 may be mounted on the top of the integrating dome lighting device 310. The imaging hole 360 may be as small as possible. The shape of the imaging hole 360 may be a circle, an ellipse or a rectangle for minimizing the area and light energy lost.

On the edge of the narrow scanning slit 350, there may be large chamfers on all four sides, so that the lighting from every direction may reach the sample object. The chamfers may be at an angle of about 45 degrees. Accordingly, the high uniform and the cloudy lighting effect may be obtained.

According to various embodiments, the mirror 320 may be replaced by a circle metal sheet with a high reflective coating, similar to the coating used in the internal surface 332 of the half-sphere dome 330.

According to various embodiments, the integrating dome lighting device 310 and/or the lighting device 210 may also be applicable to area-scan inspection apparatus, i.e. using an area camera for area scanning inspection. FIG. 5 shows a schematic diagram of an inspection apparatus 500 for area vision measurement (or area-scanning). For area vision measurement, the field of view 590 of the imaging device 570 may be a circular area or a square area. Therefore, the opening 550 on the mirror 520 may be a full circle or a square instead of the slit 350 of the mirror 320 of the inspection apparatus 300 of FIG. 3. Since the diameter of the opening (or sampling hole) 550 may be smaller than the diameter of the mirror 520, the integrating effect of the integrating dome lighting device 510 may still be significant.

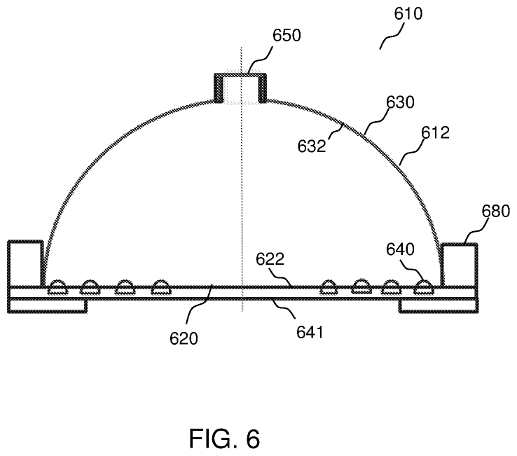

FIG. 6 shows a lighting device 610 for an inspection apparatus according to various embodiments. The lighting device 610 may be used for high speed machine vision inspection, for example coaxial lighting for an area scanning inspection. For this kind of high speed inspection, extreme strong light may be required because the exposure time is very short, for example a few micro seconds. As shown, the lighting device 610 for a coaxial lighting of an inspection apparatus may include a hollow housing 612. The hollow housing 612 may include an inner planar reflective surface 622 and an opposing inner concave dome-shaped reflective surface 632. The lighting device 610 may also include at least one light source 640 disposed at the inner planar reflective surface 622. The at least one light source 640 may be on a printed circuit board (PCB) 641. Accordingly, the inner planar reflective surface 622 may include at least one hole to accommodate the at least one light source 640 on the PCB 641 such that the at least one light source 640 on the PCT 641 may be put through the at least one hole of the inner planar reflective surface 622 to be within the hollow housing 612. According to various embodiments, the inner planar reflective surface 622 may be configured such that the PCB 641 may be sealingly coupled to the inner planar reflective surface 622 in order to prevent light from the at least one light source 640 from escaping the cavity of the hollow housing 612 through the at least one hole of the inner planar reflective surface 622. According to various embodiments, the lighting device 610 may include a plurality of light sources 640 and the inner planar reflective surface 622 may include a plurality of holes. Further, the inner planar reflective surface 622 may be configured to prevent light from the plurality of light sources 640 from escaping the cavity of the hollow housing 612 through the inner planar reflective surface 622 of the lighting device 610.

As shown in FIG. 6, the hollow housing 612 of the lighting device 610 may further include an opening 650 configured to be a light outlet. According to various embodiments, the opening 650 may be at the inner concave dome-shaped reflective surface 632 of the hollow housing 612 of the lighting device 610. According to various embodiments, the opening 650 may be at least substantially at an apex of the inner concave dome-shaped reflective surface 632. According to various embodiments, the opening 650 may be configured to be coupled with at least one fiber, such as an optic fiber, for guiding light out of the cavity of the hollow housing 612 via the opening 650. Accordingly, light from the at least one light source 640 inside the hollow housing 612 of the lighting device 610 may be subjected to multiple reflection via the inner planar reflective surface 622 and the opposing inner concave dome-shaped reflective surface 632 such that the light from the at least one light source 640 may be integrated, focused or concentrated at the opening 650 of the hollow housing 612 for the lighting device 610 to emit a high intensity light through the opening 250 for illumination of the at least one fiber. Hence the at least one fiber may emit or guide a high intensity light for used in coaxial lighting of an area scanning inspection apparatus. According to various embodiments, a bundle of fibers may be coupled to the opening 650 of the hollow housing 612.

According to various other embodiments, the opening 650 may be at the inner planar reflective surface 622 and the opposing inner concave dome-shaped reflective surface may be free of any holes, openings or apertures. Accordingly, the opening at the inner planar reflective surface 622 may be configured to be coupled with the at least one fiber for emitting or guiding a high intensity light for use in coaxial lighting of an area scanning inspection apparatus.

According to various embodiments, there may be provided a high power integrating dome lighting system for line-scan or area-scan vision inspection application. The integration lighting system may include a half-sphere dome, a group of high power LED and heat sinks, and an optical mirror. According to various embodiments, the internal surface of the half sphere may be coated with high reflectance coating and the round opening of the bottom of the hemisphere may be fully covered by a mirror. According to various other embodiments, the round opening may be at an apex of the hemisphere surface coated with high reflectance coating and the bottom of the hemisphere may be fully covered by a mirror free of any openings, holes, or slits.

According to various embodiments, the mirror may be replaced by a piece of a solid plate, on which, the internal surface may be fully coated with high reflectance coating.

According to various embodiments, the mirror or the solid plate may be mounted on a print circuit board (PCB) having a plurality of light sources. The mirror or the solid plate may include a plurality of holes to accommodate the plurality of light sources on the PCB such that the plurality of holes may be big enough to allow the light of the plurality of light sources to enter into the dome cavity and cover all of the other areas. The mirror may be configured to be coupled to the PCB such that light may not escape from the lighting device through the plurality of holes in the mirror.

For line-scanning vision inspection applications, there may be a scanning slit at the centre of the mirror for vision system to scan the sample (or target object). For area-scanning vision inspection applications, the slit may be changed to a circle hole just big enough to cover the field of view of the vision system.

According to various embodiments, the edges of the scanning opening or hole may be configured into chamfers in 45 degree for increasing the lighting angles.

A hole (or the imaging opening) on the top of the hemisphere may be configured for the digital cameras (CCD or CMOS) to take images.

According to various embodiments, there may be more than one imaging holes in the integrating dome for multiple digital cameras to take images for different vision inspection applications, such as stereo vision system for 3D inspection and so on.

According to various embodiments, there may be a number of high-power LED lights that are arranged inside of the hemisphere, and the heat sinks may be at the outside of the dome. The LED may be working on continuous lighting mode or trigger lighting mode. For the trigger light mode, the heat sink may be smaller or may totally be removed.

According to various embodiments, the optical lens and digital camera (such as CCD or CMOS camera) may be mounted on the top of the integrating dome lighting system. The imaging hole may be in the shape of a circle, an ellipse or a rectangle.

According to various embodiments, the sampling slit may be changed into a round hole such that the integrating dome light may also be converted (or become applicable) to area-scanning machine vision inspection application.

Accordingly, as shown in FIG. 2 to FIG. 6, various embodiments of the lighting device (for example the lighting device 210, 310, 510, 610) may include a hollow housing (for example the hollow housing 212, 312, 512, 612) having an inner planar reflective surface (for example the inner planar reflective surface 222, 322, 522, 622) and an opposing inner concave dome-shaped reflective surface (for example the inner concave dome-shaped reflective surface 232, 332, 532, 632). The lighting device may further include at least one light source (for example the at least one light source 240, 340, 540, 640) disposed at the inner planar reflective surface. The hollow housing may include an opening (for example the opening 250, 350, 550, 650) configured to be a light outlet.

According to various embodiments, the inner planar reflective surface of the hollow housing may be configured to be a specularly-reflective surface. Accordingly, the inner planar reflective surface of the hollow housing may include a mirror surface.

According to various embodiments, the inner planar reflective surface of the hollow housing may include a diffuse reflectance coating.

According to various embodiments, the inner concave dome-shaped reflective surface of the hollow housing may include a diffuse reflectance coating.

According to various embodiments, the at least one light source may include a light emitting diode or a high power light emitting diode.

According to various embodiments, the at least one light source may be disposed at least substantially at an edge (for example the edge 224, 324, 524) of the inner planar reflective surface.

According to various embodiments, the lighting device may further include a heat sink (for example the heat sink 380, 580, 680) coupled to the hollow housing. The heat sink may be in thermal connection with the at least one light source.

According to various embodiments, the edge of the inner planar reflective surface may be adjoining a base edge of the inner concave dome-shaped reflective surface.

According to various embodiments, the hollow housing may include a first part (for example the first part 220, 320, 520, 620) having the inner planar reflective surface and a second part (for example the second part 230, 330, 530, 630) having the opposing inner concave dome-shaped reflective surface. The first part may include a mirror forming the inner planar reflective surface. The second part may include a recess shaped to form the inner concave dome-shaped reflective surface or a hollow dome-shaped shell structure. According to various embodiments, the first part may be removably coupled to the second part.

According to various embodiments, the opening of the hollow housing may be at the inner planar reflective surface of the hollow housing. The opening of the inner planar reflective surface of the hollow housing may include a slit or a circular hole or a square hole. The opening of the inner planar reflective surface of the hollow housing may be at least substantially at a center of the inner planar reflective surface.

According to various embodiments, a region of the inner planar reflective surface abutting a boundary of the opening of the inner planar reflective surface may be chamfered.

According to various embodiments, the inner concave dome-shaped reflective surface may include an aperture (for example the aperture 260, 360, 560). The aperture of the inner concave dome-shaped reflective surface may be at least substantially at an apex of the inner concave dome-shaped reflective surface. The aperture of the inner concave dome-shaped reflective surface may include a circular hole, an ellipse hole or a rectangular hole.

According to various embodiments, the hollow housing may be configured to be coupled with an imaging device (for example the imaging device 370, 570) such that an optical axis (for example the optical axis 376, 576) of the imaging device may pass through the aperture of the inner concave dome-shaped reflective surface and the opening of the inner planar reflective surface.

According to various embodiments, the opening may be at the inner concave dome-shaped reflective surface. The opening may be at least substantially at an apex of the inner concave dome-shaped reflective surface. The opening may be configured to be coupled with at least one optic fiber for guiding light out from the opening. The inner planar reflective surface may be configured to prevent light from escaping the hollow housing through the inner planar reflective surface.

According to various embodiments, there may be provided an inspection apparatus (for example the inspection apparatus 300, 500) including the lighting device as described herein and an imaging device coupled to the lighting device. The imaging device may include an optical lens and an image sensor.

According to various embodiments, in operation, the at least one light source of the lighting device may cast a light directly on the inner concave dome-shaped reflective surface. The inner concave dome-shaped reflective surface may cause a diffuse reflection of the incident light from the at least one light source and reflect the incident light at many angles. The diffused light rays from the diffused reflection from the inner concave dome-shaped reflective surface may strike the inner planar reflective surface, which may cause a specular reflection of each of the diffused light rays back onto the inner concave dome-shaped reflective surface. The reflected light projected from the inner planar reflective surface may then be diffusely reflected again by the inner concave dome-shaped reflective surface. Accordingly, the multiple internal reflection and scattering of the light between the inner concave dome-shaped reflective surface and the inner planar reflective surface may intensify, or integrate, or focus, or concentrate light from the various reflections and the light sources to a light for emitting, casting or escaping from the opening of the hollow housing of the lighting device. Thus, the light cast out from the opening of the hollow housing of the lighting device will be a high uniform, multi-direction/shadow free and high intensity light. When the opening is at the inner planar reflective surface, depending on the shape of the opening of the inner planar reflective surface of the lighting device, the light projected from the lighting device may form a corresponding projected shape, for example a line, a circle or a square. Accordingly, the lighting device according to various embodiments may be used for uniform, multi-directional, shadow free and high intensity illumination in an inspection apparatus for line-scanning or area-scanning applications.

Various embodiments have provided a lighting device and/or a vision inspection apparatus that may be industrially applied to the field of optics and lighting, machine vision, line-scan vision inspection, two dimensional or three dimensional measurement, inspection automation, and/or inspection and dimensional measurements.

Various embodiments have provided a lighting device which uniquely may be capable of providing light with high uniformity, multidirectional/shadow free and high lighting intensity in one unit. In comparison, conventional bar lighting may focus light and may generate high intensity lighting illumination, but suffers from low uniformity and specular reflection. On the other hand, conventional dome lighting may provide light with uniformity and shadow free lighting, but suffers from low light intensity.

Various embodiments have provided a lighting device which may provide uniform lighting. The integrating dome light system and methodology according to various embodiments may generate highly uniform light illumination because of the multiple internal reflection and scattering inside of the dome

Various embodiments have provided a lighting device which may be shadow free (clouding lighting). The integrating dome light system according to various embodiments may generate cloud lighting effect, i.e. the light illumination from every direction of the whole half-sphere, non-shadow illumination. The cloudy lighting effect may enhance inspection of shining objects and featured surfaces because such lighting may overcome the specular reflection problem.

Various embodiments have provided a lighting device which may provide high power lighting. The integrating dome lighting according to various embodiments may generate very high lighting intensity since almost all of the lighting emission may be trapped inside of the dome and eventually be used for the illumination of the sample (or target object).

Various embodiments have provided a lighting device that may have a high lighting efficiency. Since the holes (imaging hole and scanning slit) may be small and the reflectivity of the surface coating of the dome and mirror may be high, most of the energy may be used for the lighting the objects to be inspected.

Various embodiments have provided a lighting device that may provide flexible lighting power selection. According to various embodiments, the total light intensity may be flexible by varying the number of the LED and their input power. If the diameter of the hemisphere is increased, there may be more room for installation of more high power LED.

Various embodiments have provided a lighting device that may have broad application. According to various embodiments, the lighting may be applicable to both line-scan and area-scan applications.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1-26. (canceled)

27. A lighting device comprising:
a hollow housing having an inner planar reflective surface and an opposing inner concave dome-shaped reflective surface; and
at least one light source disposed at the inner planar reflective surface;
wherein the hollow housing comprises an opening configured to be a light outlet, and wherein the inner planar reflective surface is configured to be a specularly-reflective surface.

28. The device as claimed in claim 27, wherein the inner planar reflective surface comprises a mirror surface.

29. The device as claimed in claim 27, wherein the inner concave dome-shaped reflective surface comprises a diffuse reflectance coating.

30. The device as claimed in claim 27, wherein the at least one light source comprises a light emitting diode in thermal connection with a heat sink coupled to the hollow housing.

31. The device as claimed in claim 27, wherein the at least one light source is disposed at least substantially at an edge of the inner planar reflective surface.

32. The device as claimed in claim 27, wherein the hollow housing comprises a first part having the inner planar reflective surface and a second part having the opposing inner concave dome-shaped reflective surface.

33. The device as claimed in claim 32, wherein the second part comprises a recess shaped to form the inner concave reflective dome-shaped surface.

34. The device as claimed in claim 32, wherein the second part comprises a hollow dome-shaped shell structure.

35. The device as claimed in claim 32, wherein the first part is removably coupled to the second part.

36. The device as claimed in claim 27, wherein the opening is at the inner planar reflective surface of the hollow housing.

37. The device as claimed in claim 36, wherein the opening of the inner planar reflective surface comprises a slit or a circular hole or a square hole.

38. The device as claimed in claim 36, wherein the opening of the inner planar reflective surface is at least substantially at a center of the inner planar reflective surface.

39. The device as claimed in claim 36, wherein a region of the inner planar reflective surface abutting a boundary of the opening of the inner planar reflective surface is chamfered.

40. The device as claimed in claim 36, wherein the inner concave dome-shaped reflective surface comprises an aperture, and wherein the hollow housing is configured to be coupled with an imaging device such that an optical axis of the imaging device passes through the aperture of the inner concave dome-shaped reflective surface and the opening of the inner planar reflective surface.

41. The device as claimed in claim 40, wherein the aperture of the inner concave dome-shaped reflective surface is at least substantially at an apex of the inner concave dome-shaped reflective surface.

42. The device as claimed in claim 40, wherein the aperture of the inner concave dome-shaped reflective surface comprises a circular hole, an ellipse hole or a rectangular hole.

43. The device as claimed in claim 27, wherein the opening is at the inner concave dome-shaped reflective surface,
wherein the opening is at least substantially at an apex of the inner concave dome-shaped reflective surface, and
wherein the opening is configured to be coupled with at least one optic fiber for guiding light out from the opening.

44. The device as claimed in claim 43, wherein the inner planar reflective surface is configured to prevent light from escaping the hollow housing through the inner planar reflective surface.

45. An inspection apparatus comprising:
a lighting device comprising:
a hollow housing having an inner planar reflective surface and an opposing inner concave dome-shaped reflective surface; and
at least one light source disposed at the inner planar reflective surface;
wherein the hollow housing comprises an opening configured to be a light outlet, and wherein the inner planar reflective surface is configured to be a specularly-reflective surface; and
an imaging device coupled to the lighting device.

46. The apparatus as claimed in claim 45, wherein the imaging device comprises an optical lens and an image sensor.
